(19) United States
(12) Patent Application Publication
(10) Pub. No.: US 2026/0333555 A1
(43) Pub. Date: Oct. 22, 2026

(54) X-RAY SOURCE WITH INDIVIDUALLY CONTROLLED FILAMENTS USING ELECTRON CURRENT FEEDBACK

(71) Applicant: John Thomas Canazon, Oxford, GA (US)

(72) Inventor: John Thomas Canazon, Oxford, GA (US)

(21) Appl. No.: 19/566,036

(22) Filed: Mar. 13, 2026

Related U.S. Application Data
(60) Provisional application No. 63/771,498, filed on Mar. 13, 2025.

(51) Int. Cl. H05G 1/34; H05G 1/08; H05G 1/10; H05G 1/26; H05G 1/36

(52) U.S. Cl. CPC H05G 1/34; H05G 1/085; H05G 1/10; H05G 1/265; H05G 1/36

(57) ABSTRACT

An X-ray source includes multiple filaments, each configured to emit electrons when heated, and at least one anode to generate X-rays from the emitted electrons. Each filament is independently controlled using a feedback loop that measures the electron current to the anode and adjusts the filament’s heating current to maintain a predetermined value. This ensures uniform X-ray emission and protects each filament from thermal overload. The anode may be a single structure with multiple sections or multiple discrete anodes and the control systems can be positioned within the X-ray tube, the high-voltage power supply or an intermediate enclosure.

### CROSS-REFERENCE TO RELATED APPLICATIONS

This application claims the benefit of US Provisional Patent Application Serial No. 63/771,498, filed Mar. 13,2025, the entirety of which is hereby incorporated herein by reference.

### BACKGROUND OF THE INVENTION

### 1. Field of the Invention

The present invention relates to an X-ray source with individually controlled filaments using electron current feedback.

### 2. Description of the Related Art

Traditional X-ray sources often employ multiple filaments connected in series, sharing a single heating current. This configuration can lead to uneven electron emission due to inherent differences in filament characteristics or degradation over time, resulting in non- uniform X-ray output and increased risk of filament burnout. In other systems, X-ray uniformity around the tube has been measured as uneven, and systems where the filaments have 100% duty cycles have relatively short life when run continuously for high dose applications. Existing solutions lack precise, individual control over each filament, limiting their ability to maintain consistent performance and durability.

Therefore, there is a need for a system that provides independent feedback control for each filament based on its electron current. There is also a need for a system that provides per-filament real-time adjustment based on measured anode-directed electron current.

### SUMMARY OF THE INVENTION

The disadvantages of the prior art are overcome by the present invention which, in one aspect, is an X-ray source having multiple Filaments, wherein each filament emits electrons when heated, enabling distributed electron emission. At least one anode is configured to receive electrons and generate X-rays. Each filament has its own adjustable heating current source. A high-voltage supply accelerates electrons from the filaments to the anode(s). A current sensor measures the electron current from each filament to the anode, and a control system adjusts the heating current to maintain a set electron current value.

This configuration ensures uniform X-ray emission across all filaments, protects individual filaments from overheating and allows flexibility in anode design and control system placement. Applications include ionizing radiation for blood transfusions, cannabis mold treatment, virus deactivation, and insect sterilization, plus medical imaging, industrial inspection, and scientific research.

This device can be used in such applications as: : ionizing radiation for blood transfusions, cannabis mold treatment, virus deactivation, insect sterilization, medical imaging, industrial inspection, and scientific research.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of a four filament bi-directional embodiment.

FIG. 2 is a schematic diagram of a four filament radial embodiment.

FIG. 3 is a schematic diagram of a four filament linear embodiment.

FIG. 4 is a schematic diagram of a four filament embodiment employing four separate high voltage sources.

FIG. 5 is a schematic diagram of a three filament embodiment employing a current balancer.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of "a," "an," and "the" includes plural reference, the meaning of "in" includes "in" and "on."

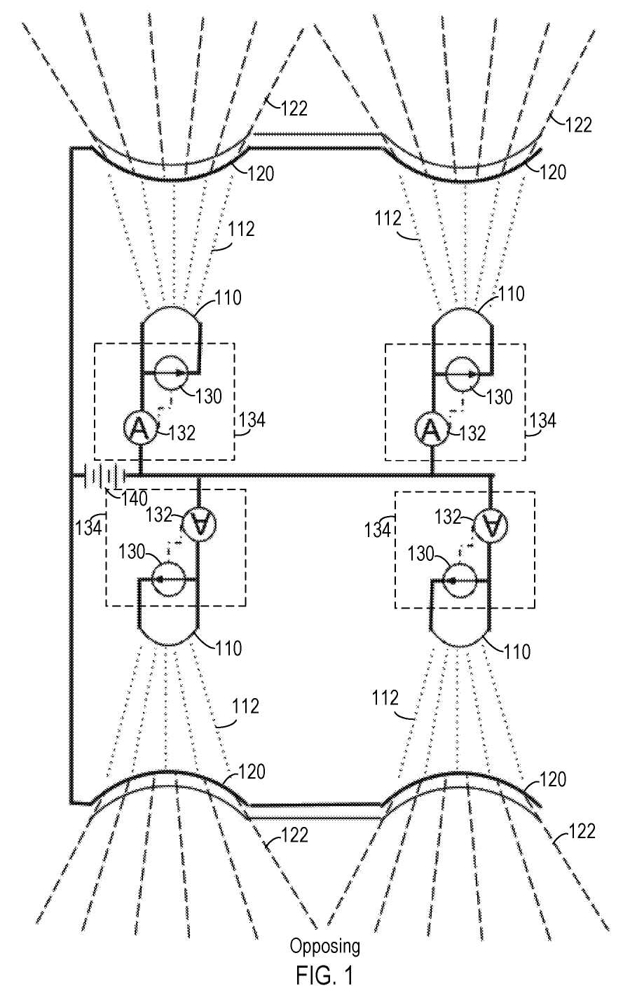

As shown in FIG. 1, one embodiment includes a plurality of filaments 110 (e.g., tungsten or similar materials) housed within a vacuum enclosure (not shown). Each filament 110 emits electrons 112 via thermionic emission when heated, which is controlled by a feedback controller 134. The electrons 112 strike the anodes 120 causing the anodes to emit x- rays 122. Each filament 110 has a separately-controllable power supply 130 that delivers a heating current thereto to control electron emission. A high-voltage generator 140 applies a negative potential to the filaments relative to the anode(s), causing electrons 112 to accelerate toward the anode(s) to produce X-rays 122.

Current sensing circuits 132 (e.g., sense resistors, current transformers) measure the electron current from each filament 110 to the anode(s) 120. These circuits 132 can be disposed within the X-ray tube, high-voltage supply, or an intermediate enclosure.

The feedback controllers 134 (e.g., proportional-integral-derivative (PID) controllers) sense current in each filament 110 and adjust the heating current produced by the controllable power supply 130 based on measured electron current to maintain a predetermined value. The feedback controllers 134 can be co-located with the current sensors or distributed across the system.

In operation, each filament 110 is heated, thereby emitting electrons toward the anode(s) 120. The electron current from each filament 110 to the anode(s)120 is measured independently. The control system 134 compares the measured current to a set value and adjusts the heating current accordingly. This results in consistent electron emission across all filaments 110, which results in uniform X-ray output and prolonged filament life. One or more filaments 110 are emitting electrons at the same time (i.e., simultaneously). This system allows for different duty cycles for the different filaments 110, which can extend the lifetime of each filament 110. Filaments 110 can be operated simultaneously or in an alternating pattern, which increases filament life. Also, all of the filaments 110 can be energized concurrently to produce a greater x-ray concentration.

The system lends itself into many different configurations. Several different embodiments employ different anode configurations, such as:
Single anode with multiple sections for compact designs; and
Multiple anodes for modular or specialized X-ray outputs.

The control system 134 can be placed within the X-Ray Tube, which integrates control for a self-contained unit. It can also be placed in the high-voltage supply, which may simplify the tube design and maintenance. Placement in the intermediate enclosure can balance modularity and accessibility. The system is adaptable and supports various filament arrangements and electron current set points tailored to specific applications.

Several exemplary embodiments are presented below:

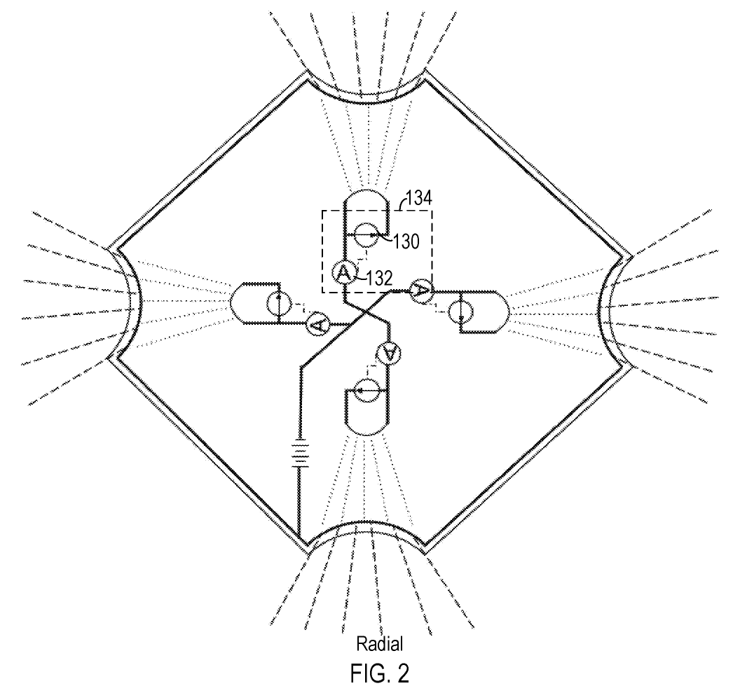

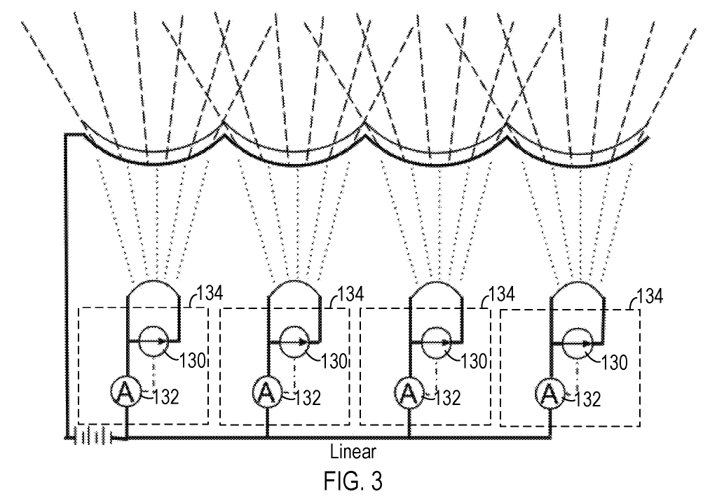

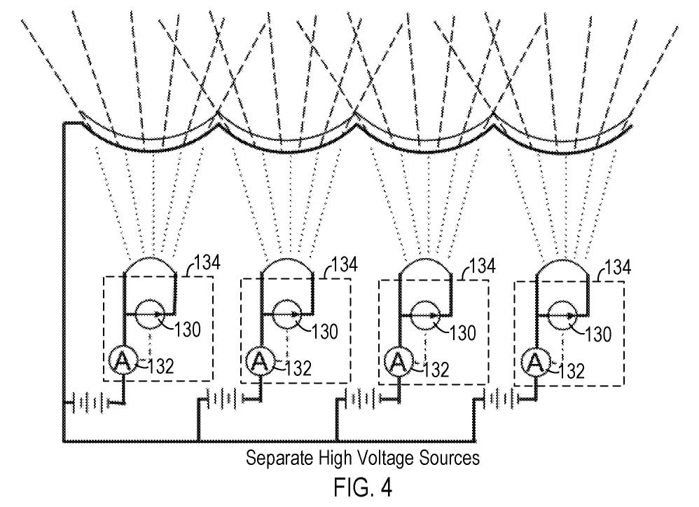

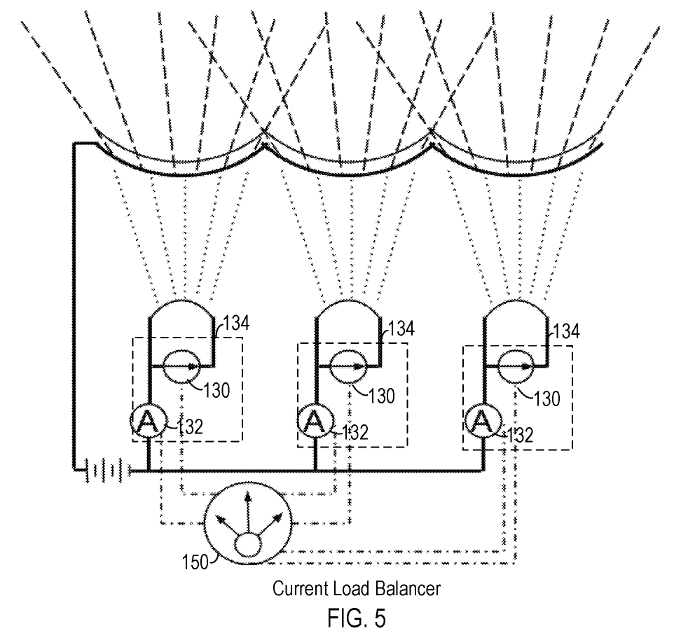

A radial embodiment is shown in FIG. 2. A linear embodiment is shown in FIG. 3. An embodiment employing separate voltage sources is shown in FIG. 4. An embodiment employing a current load balancer 150, which balances the current load between different filaments, is shown in FIG. 5.

In a single anode embodiment, five filaments can be linearly arranged, each targeting a distinct section of a single anode. Electron currents are measured at 1 mA per filament and maintained via PID controllers adjusting heating currents. This results in a uniform X-ray field across the anode.

In a multiple anode embodiment, three filaments can be each paired with a separate anode. Independent feedback loops maintain 0.5 mA per filament-anode pair. This results in customizable X-ray outputs from discrete sources.

In a mixed placement embodiment, current sensing can be done within the X-ray tube and the control systems are in the high-voltage supply. Electron currents are stabilized at 2 mA per filament. This results in enhanced design flexibility and maintenance ease.

The X-ray tube may be powered by a single high voltage power supply capable of controlling the current through the filaments by measuring the current of electrons being emitted from it. All the filaments will be on simultaneously. This adds protection to the filaments by limiting the current in each filament that otherwise could lead to premature failure. This can also help to produce a more uniform distribution of x rays surrounding the tube.

In the figured there is a circle with an "A", this represents a current sensing method. There is a circle with an arrow, this represents a current control method. There is a dashed/dotted line between the two to show that the sensing method controls the current in the filament with a feedback loop.

The current control circuit may have all or some of the components located either in the x-ray tube, the high voltage power supply, or a control box located between the x-ray tube and the power supply.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described herein, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, "each" refers to each member of a set or each member of a subset of a set. It is intended that the claims and claim elements recited below do not invoke 35 U.S.C. § 112(f) unless the words "means for" or "step for" are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An X-ray source comprising:
(a) a plurality of filaments, each configured to emit a corresponding plurality of electron streams when heated;
(b) at least one anode configured to receive the electron streams from the plurality of filaments and generate X-rays;
(c) a high-voltage supply connected to the plurality of filaments and the at least one anode to accelerate electrons from the filaments to the at least one anode;
(d) for each filament, a heating power supply configured to provide a heating current to the filament;
(e) for each filament, a current sensing device configured to measure an electron current from the filament to the at least one anode; and
(f) for each filament, a control system configured to adjust the heating current based on the measured electron current to maintain the electron current at a set value,
wherein each control system independently maintains a distinct set electron current value per filament based solely on its measured electron current.

2. The X-ray source of claim 1, wherein the at least one anode comprises a single anode with multiple sections, each section configured to receive electrons from one or more corresponding filaments.

3. The X-ray source of claim 1, wherein the at least one anode comprises multiple discrete anodes, each configured to receive electrons from one or more filaments.

4. The X-ray source of claim 1, wherein the current sensing means and the control system for each filament are located within the X-ray tube.

5. The X-ray source of claim 1, wherein the current sensing means and the control system for each filament are located in the high-voltage power supply.

6. The X-ray source of claim 1, wherein the current sensing means and the control system for each filament are located in an enclosure between the X-ray tube and the high-voltage power supply.

7. The X-ray source of claim 1, wherein the current sensing means comprises a sense resistor in series with the filament’s connection to the high-voltage supply.

8. The X-ray source of claim 1, wherein the control system comprises a proportional-integral-derivative (PID) controller.

9. The X-ray source of claim 1, wherein the plurality of filaments is arranged in an array to provide a uniform X-ray field.

10. The X-ray source of claim 1, wherein the set value for the electron current is the same for all filaments to achieve uniform X-ray emission.

11. The X-ray source of claim 1, further comprising means to monitor the temperature of each filament.

12. The X-ray source of claim 1, wherein the heating power supplies are electrically isolated from one another.

13. The X-ray source of claim 1, wherein each electron stream strikes a different and separate spot on the anode so as not to overlap.

14. The X-ray source of claim 1, wherein at least two of the filaments are emitting electrons at the same time.

15. A method of operating an X-ray source having a plurality of filaments and at least one anode, the method comprising the steps of:
(a) for each filament, measuring an electron current from the filament to the at least one anode; and
(b) for each filament, adjusting a heating current to the filament based on the measured electron current to maintain the electron current at a set value.
